(19) United States
(12) Patent Application Publication
(10) Pub. No.: US 2023/0245556 A1
(43) Pub. Date: Aug. 3, 2023

(54) SYSTEM AND METHOD OF USING BASE STATION ALGORITHM TO PLAN EMERGENT TRAFFIC ROUTE AND INFORM IN ADVANCE VEHICLES TO YIELD RIGHT-OF-WAY

(71) Applicant: FAR EASTONE TELECOMMUNICATIONS CO., LTD., Taipei City (TW)

(72) Inventors: CHUNG HWA RAO, Taipei City (TW); HUA-PEI CHIANG, TAIPEI CITY (TW); CHYI-DAR JANG, TAIPEI CITY (TW); TSUNG-JEN WANG, TAIPEI CITY (TW); TSZ KWONG LEUNG, TAIPEI CITY (TW)

(21) Appl. No.: 17/867,415

(22) Filed: Jul. 18, 2022

(30) Foreign Application Priority Data
Jan. 28, 2022 (TW) 111104196

(51) Int. Cl. G08G 1/01; H04W 4/40; G01C 21/34; G08G 1/0967

(52) U.S. Cl. CPC G08G 1/0141; H04W 4/40; G01C 21/3407; G08G 1/096708

(57) ABSTRACT

A system and method of using a base station algorithm to plan an emergent traffic route and inform in advance vehicles to yield right-of-way, wherein the cloud server receives the current position and destination position of a rescue vehicle through base stations. The cloud server determines the positioned locations of the mobile devices. The cloud server comparing the positioned locations with a map to plan a fastest route for the rescue vehicle to reach the destination position. The cloud server send out radio frequency notification to the mobile devices on the fastest route to remind the mobile devices to yield right-of-way. The present invention enables the rescue vehicle to avoid jammed roads and finds out the fastest route for the rescue vehicle. Further, the present invention may remind road users to yield right-of-way. Thereby, the rescue vehicle can reach the accident spot faster.

This application claims priority of application Ser. No. 11/104,196 filed in Taiwan on 28 Jan. 2022 under 35 U.S.C. § 119; the entire contents of all of which are hereby incorporated by reference.

### BACKGROUND OF THE INVENTION

### Field of the Invention

The present invention relates a route planning method, particularly to a system and method of using a base station algorithm to plan an emergent traffic route and inform in advance vehicles to yield right-of-way.

### Description of the Prior Art

Rescue vehicles, such as ambulances and fire engines, should arrive at the accident spot as fast as possible. Therefore, rescue vehicles are equipped with sirens and flash lights to remind road users to yield right-of-way lest rescue actions be hindered.

While performing rescue actions, rescue vehicles may encounter traffic jams. In such a scenario, the rescue vehicles can only use sirens to remind the passengers and vehicles ahead to yield right-of-way. However, too big a volume of sirens may disturb the residents of the regions the rescue vehicles pass or the people in the hospitals. If the volume of sirens is too small, the neighboring vehicles can neither find the situation early nor yield right-of-way in advance. Besides, road users may have heard sirens very early, but they cannot recognize the correct position of the rescue vehicle. In such a case, they cannot determine whether they should take actions to yield right-of-way.

Accordingly, the present invention proposes a system and method of using a base station algorithm to plan an emergent traffic route and inform in advance vehicles to yield right-of-way, whereby to solve the conventional problem and meet the future requirement. The principles and embodiments of the present invention will be described in detail below.

### SUMMARY OF THE INVENTION

The primary objective of the present invention is to provide a system and method of using a base station algorithm to plan an emergent traffic route and inform in advance vehicles to yield right-of-way, which uses base stations of mobile networks to collect related information of mobile network environments of the vehicles and passengers along the route the rescue vehicle may pass and immediately transmits information to cloud servers for analysis and planning, whereby to plan the fastest route for the rescue vehicle.

Another objective of the present invention is to provide a system and method of using a base station algorithm to plan an emergent traffic route and inform in advance vehicles to yield right-of-way, which detects the mobile devices on the fastest route, including the mobile devices that enter the fastest route newly, and transmits radio frequency notifications to inform passengers and vehicles to yield right-of-way manually or automatically.

In order to achieve the abovementioned objectives, the present invention provides a system of using a base station algorithm to plan an emergent traffic route and inform in advance vehicles to yield right-of-way, which is suitable to link with mobile devices of a plurality of vehicles and receive mobile network signals from the mobile devices of the plurality of vehicles, whereby to plan a fastest route for a rescue vehicle. The system of using a base station algorithm to plan an emergent traffic route and inform in advance vehicles to yield right-of-way comprises a plurality of base stations, which is in signal communication with mobile devices within the effective signal ranges thereof and receives mobile network signals persistently to generate a plurality of pieces of measurement information; and a cloud server, which is in signal communication with the base stations and a rescue vehicle, receives mobile network signals, measurement information, the current position and destination position of the rescue vehicle, and analyzes the measurement information of the base stations to determine the positioned locations of mobile devices, and compares the positioned locations with a map to plan a fastest route through which the rescue vehicle can reach the destination point. The cloud server also transmits at least one radio frequency notification to the mobile devices on the fastest route to inform the mobile devices to yield right-of-way.

In one embodiment, the vehicles include a plurality of autonomous vehicles and a plurality of traditional vehicles. The autonomous vehicle includes a control unit and a mobile device. While at least one of the autonomous vehicle receives the radio frequency notification, the control unit controls the autonomous vehicle to yield right-of-way.

In one embodiment, the measurement information includes at least one of Reference Symbol Received Power (RSRP), Reference Signal Receiving Quality (RSRQ), Signal to Interference plus Noise Ratio (SINR), Channel Quality Indicator (CQI), Angle of Arrival (AoA), Timing Advance (TA), Round-Trip Time (RTT) of the mobile devices, and Cell-ID, locations, neighborhood lists, and Channel Status Information (CSI) of the base stations.

In one embodiment, the cloud server includes a communication interface for signal communication with base stations.

In one embodiment, the cloud server plans the fastest route from a plurality of routes according to the lengths of the plurality of routes, the quantities of mobile devices on each route, the moving directions and moving speeds of the mobile devices; the cloud server also lists the mobile devices on the fastest route.

In one embodiment, before using the measurement information of base stations to calculate the fastest route, the cloud server lists the base stations between the current position and destination position of the rescue vehicle to facilitate the analysis of the measurement information of the base stations.

In one embodiment, the cloud server finds out the mobile devices on the fastest route and determines whether each of the mobile devices is indoor or outdoor according to the moving behaviors thereof; then the cloud server arranges the outdoor mobile devices in a notification list and transmits radio frequency notifications to the mobile devices on the notification list through the base stations.

In one embodiment, radio frequency notifications are transmitted to mobile devices through cell signaling of base stations.

In one embodiment, the frequencies of transmitting radio frequency notifications are dependent on the moving speeds of each mobile devices, the moving speed of the rescue vehicle, and the relative distances between the mobile devices and the rescue vehicle.

The present invention also provides a method of using a base station algorithm to plan an emergent traffic route and inform in advance vehicles to yield right-of-way, which comprises steps: a plurality of base stations persistently receiving a plurality of mobile network signals of a plurality of mobile devices within the effective signal ranges thereof to generate a plurality of pieces of measurement information; after a cloud server receives a current position and a destination position of a rescue vehicle, the cloud server receiving measurement information of base stations from the base stations between the current position and the destination position and analyzing the measurement information to determine the positioned locations of the mobile devices; comparing the positioned locations with a map, the cloud server planning a fastest route to the destination position for the rescue vehicle; and the cloud server transmitting at least one radio frequency notification through the base stations to the mobile devices on the fastest route to inform the mobile devices to yield right-of-way.

### BRIEF DESCRIPTION OF THE DRAWINGS

FIG. 1 schematically shows an architecture of a system of using a base station algorithm to plan an emergent traffic route and inform in advance vehicles to yield right-of-way according to one embodiment of the present invention.

FIG. 2 schematically shows an embodiment of a system of using a base station algorithm to plan an emergent traffic route and inform in advance vehicles to yield right-of-way according to one embodiment of the present invention.

FIG. 3 shows a flowchart of a method of using a base station algorithm to plan an emergent traffic route and inform in advance vehicles to yield right-of-way according to one embodiment of the present invention.

FIG. 4 schematically shows that an autonomous vehicle and a traditional vehicle receive a radio frequency notification according to one embodiment of a method of using a base station algorithm to plan an emergent traffic route and inform in advance vehicles to yield right-of-way of the present invention.

### DETAILED DESCRIPTION OF THE INVENTION

Below, the technical schemes of the present invention will be clearly and fully described with embodiments and attached drawings. However, it should be understood: the described embodiments are not all the embodiments of the present invention but only a portion of the embodiments of the present invention. Based on the embodiments of the present invention, any embodiment made by a person skilled in the art without contributing non-obviousness is to be also included by the scope of the present invention.

It should be understood: in the specification and claims, the terms “comprise” and “include” indicate the existence of the described characteristics, entirety, steps, operations, elements and/or members. However, the terms “comprise” and “include” do not exclude the existence or addition of one or a plurality of characteristics, entirety, steps, operations, elements, members and/or the combinations thereof.

It should be also understood: the terms used in the specification are only to describe specified embodiments but not to limit the scope of the present invention. The noun described by a singular adjective “a”, “one” or “the/the” may include the plural forms except another case is clearly indicated hereinbefore or thereinafter.

It should be also understood: the term “and/or” used in the specification and claims indicates one or any one combination or all possible combinations of the listed items.

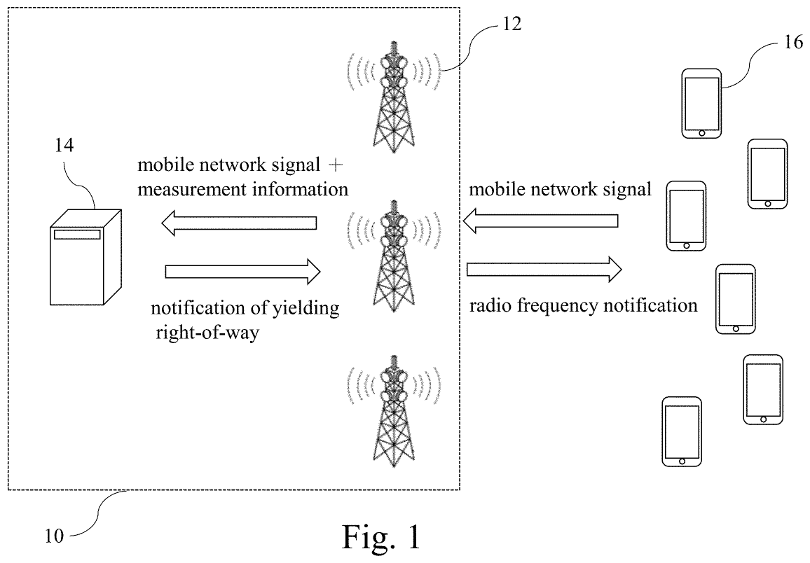

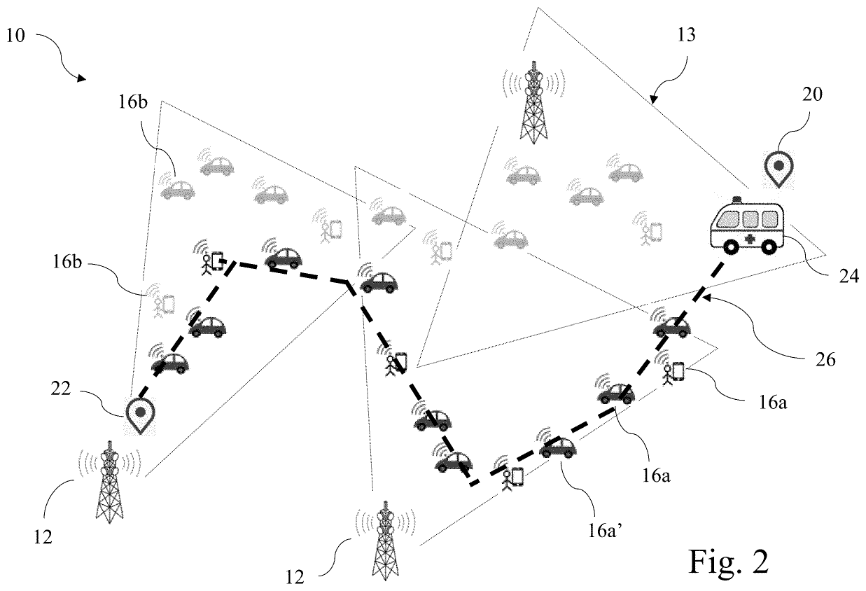

The present invention provides a system and method of using a base station algorithm to plan an emergent traffic route and inform in advance vehicles to yield right-of-way. Refer to FIG. 1 and FIG. 2. FIG. 1 schematically shows an architecture of a system 10 of using a base station algorithm to plan an emergent traffic route and inform in advance vehicles to yield right-of-way according to one embodiment of the present invention. FIG. 2 schematically shows an embodiment of the system 10 of using a base station algorithm to plan an emergent traffic route and inform in advance vehicles to yield right-of-way according to one embodiment of the present invention. The system 10 of using a base station algorithm to plan an emergent traffic route and inform in advance vehicles to yield right-of-way of the present invention is suitable to link with mobile devices 16 and receive mobile network signals, whereby to plan a fastest route for a rescue vehicle 24. Rescue vehicles may be ambulances or fire engines, which should arrive at the accident spot as fast as possible. However, the present invention does not limit that the rescue vehicle must be an ambulance or a fine engine. In the present invention, rescue vehicles include the vehicles that must arrive at the spots fast and require other vehicles to yield right-of-way.

The system 10 of using a base station algorithm to plan an emergent traffic route and inform in advance vehicles to yield right-of-way of the present invention comprises a plurality of base stations 12 and a cloud server 14. The base station 12 is a 4G network base station or a 5G network base station of mobile devices. The base stations 12 are in signal communication with mobile devices 16 within the effective signal ranges thereof and persistently receive the mobile network signals emitted by the mobile devices 16. The coverages of the base stations 12 are different but overlap to guarantee that the mobile network signals from everywhere can be received. The base stations 12 generate a plurality of measurement information according to the mobile network signals of the mobile devices 16. The measurement information can assist in determining the positioned locations of the mobile devices 16.

The measurement information include at least one of Reference Symbol Received Power (RSRP), Reference Signal Receiving Quality (RSRQ), Signal to Interference plus Noise Ratio (SINR), Channel Quality Indicator (CQI), Angle of Arrival (AoA), Timing Advance (TA), and Round-Trip Time (RTT) of the mobile devices 16, Cell-ID, locations, neighborhood lists, and Channel Status Information (CSI) of the base stations 12. In the present invention, the synchronous reference signal power received by the mobile device (User Equipment (UE)) 16 at present may be used to determine the intensity of the signal decayed by a given distance of transmission and thus may be used as a reference value of the distance between the mobile device 16 and the base station 12. The synchronous reference signal quality received by the mobile device 16 at present may be used to determine the quality variation of the signals transmitted by the service base station and the other base stations 12 to the mobile device 16 and thus may be used as a reference value to determine the distance. The Signal to Interference plus Noise Ratio (SINR) is the ratio of the intensity the received effective signal to the intensity of the received interference signal (interference and noise). SINR may be used to determine the interference induced by the signal overlap of the base stations 12 around a spot and thus may be used a reference to evaluate broadcasting to the user and determine the signal quality of the moving user. The Channel Quality Indicator (CQI) that the mobile device 16 reports to the base station 12 periodically may be used to evaluate the signal quality between the mobile device 16 and the base station 12 and thus may be used as a reference to evaluate radio frequency notifications and signal quality variation of moving mobile device 16. The radio frequency notifications may be in form of broadcasts, short messages, control signals, push notifications, packets, or other types of radio frequency notifications. The phase differences of the upward signals received by a plurality of antennae of the base stations 12 may be used to calculate the Angle of Arrival (AoA) of the received signals and thus may be used to calculate the relative direction and angle of the base station 12 and the mobile device 16, whereby the relative position of the mobile device 16 is determined. Timing Advance (TA) is the time difference between the signal transmitting end and the signal receiving end and may be used to determine the transmission lag between the base station 12 and the mobile device 16, whereby to determine the relative position of the mobile device 16. Round-Trip Time (RTT) is the average time interval between the time point of transmitting a packet and the time point of receiving the response to the packet and may be used to determine the time lag of the transmission between the base station 12 and the mobile device 16, whereby to determine the relative position of the mobile device 16. Cell-ID is used to label different base stations 12 and corresponding to related information, such as the latitude and longitude of the base station and the type of the signals transmitted by the antenna, whereby to determinate the relative position of the base station 12 and the mobile device 16. The location of the base station discloses the latitude and longitude information of the base station 12 and may be used to determine the relative position of the base station 12 and the mobile device 16. The neighborhood list of the base station is a reference used to determine whether the mobile device 16 can undertake handoff between the base station 12 and anther base station 12 in the neighborhood and thus may be used to determine the coverages of the base stations 12. Channel Status Information (CSI) is the wireless channel information that the mobile device 16 reports to the base station 12 at present, including the channel characteristics of the wireless channel, such as the signal attenuation induced by scattering, decay, and distance, whereby to determinate the relative position of the base station 12 and the mobile device 16.

The cloud server 14 links to the base stations 12 and the rescue vehicle 24 through a communication interface (not shown in the drawings). The cloud server 14 includes software modules and/or hardware modules, such as a monitoring module, a database, a cloud information retrieving and processing module, and a digital suggestion module (none of them is shown in the drawings). All the actions of these modules are performed by a processor (not shown in the drawings). The monitoring module persistently receives the mobile network signals and measurement information sent out by the base stations 12. The measurement information is stored in the database. The cloud information retrieving and processing module positions the mobile devices and analyzes the moving path of the rescue vehicle. Then, the digital suggestion module undertakes comparison and suggests a fastest route. The cloud server 14 receives mobile network information, measurement information, a current position 20 of a rescue vehicle 24, and a destination position 22 of the rescue vehicle 24. Then, the cloud server 14 determines the positioned location of the mobile device 16, plans the fastest route to the destination position 22, and transmits at least one radio frequency notification to other mobile devices on the fastest route.

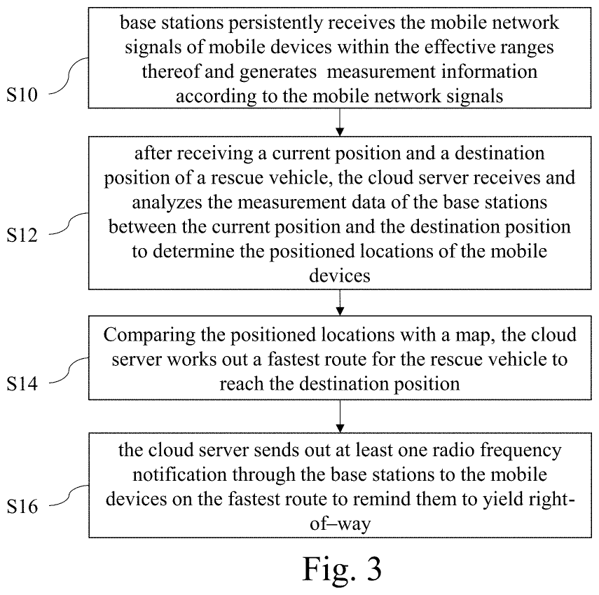

Refer to FIG. 2 and FIG. 3. FIG. 3 show a flowchart of a method of using a base station algorithm to plan an emergent traffic route and inform in advance vehicles to yield right-of-way according to one embodiment of the present invention. In Step S10, a plurality of base stations 12 persistently receives the mobile network signals of a plurality of mobile devices 14 within the effective ranges thereof and generates a plurality of pieces of measurement information according to the mobile network signals. In Step S12, after receiving a current position 20 of a rescue vehicle 24 and a destination position 22 of the rescue vehicle 24, the cloud server 14 receives and analyzes the measurement information of the base stations 12 between the current position 20 and the destination position 22 to determine the positioned locations of the mobile devices. The positional coordinates of the rescue vehicle 24 and the base stations 12 may be provided by the Global Positioning System (GPS). In Step S12, the cloud server 14 lists the base stations 12 between the current position 20 and the destination position 22 and abandons other base stations for reducing the information volume of computation. In Step S14, the cloud server 14 plans a fastest route 26 for the rescue vehicle 24 to reach the destination position 22 fastest according to compare the positioned locations of the mobile devices 16 with a map, such as a Google Map. In detail, the cloud server 14 finds out a plurality of routes able to reach the destination position 22 beforehand; next, the cloud server 14 plans a fastest route according to the lengths of the routes, the quantities of the mobile devices on the routes, the moving directions of the mobile devices, and the moving speeds of the mobile devices; then, the cloud server 14 lists the mobile devices on the fastest route. While the cloud server 14 provides the fastest route for the rescue vehicle 24, the provided information includes the moving direct and street names. In Step S16, the cloud server sends out at least one notification of yielding right-of-way; the base stations 12 wirelessly transmit the at least one notification of yielding right-of-way in form of radio frequency to the mobile devices 16a, which are on the fastest route, to remind the mobile devices 16a to yield right-of-way. However, the mobile devices 16b, which are not on the fastest route, would not receive the radio frequency notification of yielding right-of-way.

In one embodiment, the method of the present invention further comprises a step: analyzing whether the mobile device 16 is inside or outside a building, which is performed after the fastest route is found out in Step S14 and before the radio frequency notification is sent out in Step S16. No matter whether the satellite positioning technology, the base-station triangle positioning technology, or another positioning technology is used, it will position the mobile devices inside and outside buildings. The present invention needs to find out the outdoor mobile devices 16, which are moving on the roads and may impair the movement of the rescue vehicle 24. Therefore, the cloud server 14 performs analysis to determine whether the mobile device 16 is indoor or outdoor according to the behaviors thereof and determine whether the mobile device is carried by a person or a vehicle according to the moving speed and geographic location thereof. The cloud server 14 arranges the mobile devices 16a, which are outdoor and on the fastest route, in a notification list, and wirelessly transmits a radio frequency notification to the mobile devices 16a on the notification list. In the present invention, the radio frequency notification is transmitted to the mobile devices 16a through the cells of the base stations 12.

The frequency of transmitting the radio frequency notification is dependent on the moving speed of the mobile device 16a, the moving speed of the rescue vehicle 24, the relative distance between the mobile device 16a and the rescue vehicle 24. For example, if a pedestrian walks slowly, the notification is transmitted to the pedestrian once per 30 seconds; the notification is transmitted to an ordinary vehicle once per 10 seconds. While the mobile device 16a and the rescue vehicle 24 are getting more and more close, the frequency of transmitting the radio frequency notification is increased.

As the cloud server 14 persistently receives the mobile network signals and measurement information sent out by the base stations 12, the calculation results are updated constantly. For example, the cloud server 14 calculates and determines whether there is any new mobile device entering the fastest route. If the answer is yes, the new mobile device is added to the notification list. If there is a mobile device leaving the fastest route, the mobile device is removed from the notification list. Thereby, as soon as a road user enters the moving route of the rescue vehicle 24, the road user will receive the radio frequency notification, learn the distance between the road user and the rescue vehicle 24, and determine when he needs to yield right-of-way. The system and method of using a base station algorithm to plan an emergent traffic route of the present invention not only can significantly increase the speed of the rescue vehicle to the destination position but also let the corresponding road users learn that they are on the same route as the rescue vehicle. Further, even though the road users on other routes have heard sirens, they can make sure that they will not interfere with the rescue vehicle and may keep on going ahead unworriedly.

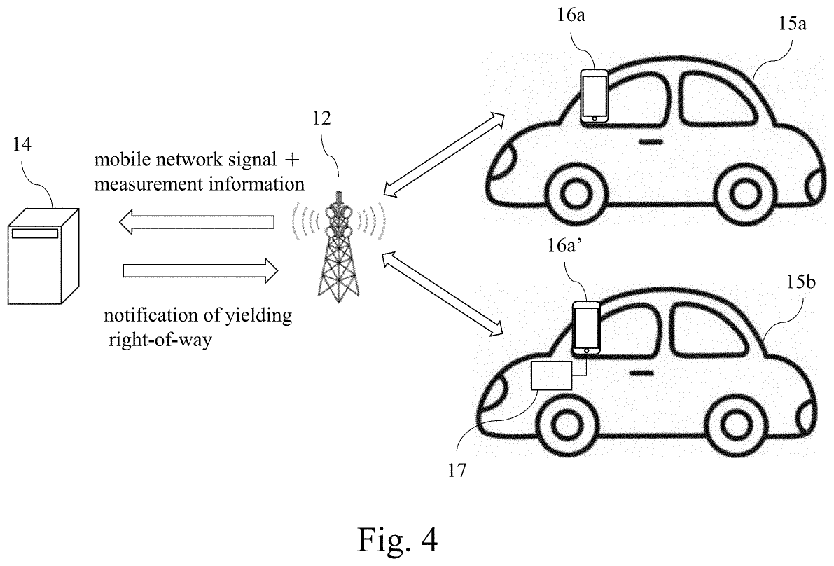

FIG. 4 schematically shows that an autonomous vehicle and a traditional vehicle receive a radio frequency notification according to the method of using a base station algorithm to plan an emergent traffic route and inform in advance vehicles to yield right-of-way of the present invention. FIG. 4 includes a traditional vehicle 15a and an autonomous vehicle 15b. The traditional vehicle 15a is equipped with a mobile device 16a. After the mobile device 16a receives the radio frequency notification of yielding right-of-way, the driver (not shown in the drawing) of the traditional vehicle 16a will manually drive the traditional vehicle 15a to yield right-of-way according to the notification on the mobile device 16a. The autonomous vehicle 15b is equipped with a control unit 17 and a mobile device 16a′. Once the mobile device 16a′ of the autonomous vehicle 15b receives the radio frequency notification that is sent out by the cloud server 14 through the base station 12, the control unit 17 will automatically control the autonomous vehicle 15b to yield right-of-way. In one embodiment not shown in the drawings, the control unit 17 and the mobile device 16a′ are not independent units but integrated in the vehicle computer.

The embodiments described above are only to exemplify the present invention but not to limit the scope of the present invention. Any equivalent modification or variation according to the spirit or characteristics of the present invention is to be also included by the scope of the present invention.

What is claimed is:

1. A system of using a base station algorithm to plan an emergent traffic route and inform in advance vehicles to yield right-of-way, which is suitable to link with a plurality of mobile devices of a plurality of vehicles and receive a plurality of mobile network signals from the mobile devices to plan a fastest route for a rescue vehicle, comprising
a plurality of base stations, in signal communication with the mobile devices within effective signal ranges thereof and persistently receiving the mobile network signals to generate a plurality of pieces of measurement information; and
a cloud server, in signal communication with the base stations and the rescue vehicle, receiving the mobile network signals, the pieces of measurement information, a current position of the rescue vehicle and a destination position of the rescue vehicle, analyzing the pieces of measurement information of the base stations to determine positioned locations of the mobile devices, planning the fastest route of the rescue vehicle to reach the destination position by comparing the positioned locations with a map, and transmitting at least one radio frequency notification through the base stations to the mobile devices on the fastest route to remind the mobile devices to yield right-of-way.

2. The system of using a base station algorithm to plan an emergent traffic route and inform in advance vehicles to yield right-of-way according to claim 1, wherein the vehicles includes a plurality of autonomous vehicles and a plurality of traditional vehicles; each of the autonomous vehicles includes a control unit and one of the mobile devices; after at least one of the autonomous vehicles receives the radio frequency notification, the control unit controls the autonomous vehicle which received the radio frequency notification to yield right-of-way.

3. The system of using a base station algorithm to plan an emergent traffic route and inform in advance vehicles to yield right-of-way according to claim 1, wherein the measurement information includes at least one of Reference Symbol Received Power (RSRP), Reference Signal Receiving Quality (RSRQ), Signal to Interference plus Noise Ratio (SINR), Channel Quality Indicator (CQI), Angle of Arrival (AoA), Timing Advance (TA), and Round-Trip Time (RTT) of the mobile devices; and Cell-ID, locations, neighborhood lists of base stations, and Channel Status Information (CSI) of the base stations.

4. The system of using a base station algorithm to plan an emergent traffic route and inform in advance vehicles to yield right-of-way according to claim 1, wherein the cloud server includes a communication interface for signal communication with the base stations.

5. The system of using a base station algorithm to plan an emergent traffic route and inform in advance vehicles to yield right-of-way according to claim 1, wherein the cloud server plans the fastest route according to lengths of a plurality of routes, quantities of the mobile devices on the routes, moving directions of the mobile devices on the routes, and moving speeds of the mobile devices on the routes; the cloud server lists the mobile devices that is on the fastest route.

6. The system of using a base station algorithm to plan an emergent traffic route and inform in advance vehicles to yield right-of-way according to claim 1, wherein before using the pieces of measurement information of the base stations to calculate the fastest route, the cloud server lists the base stations between the current position of the rescue vehicle and the destination position of the rescue vehicle and analyzes the pieces of measurement information of the base stations.

7. The system of using a base station algorithm to plan an emergent traffic route and inform in advance vehicles to yield right-of-way according to claim 1, wherein the cloud server finds out the mobile devices moving on the fastest route currently, determines whether each of the mobile devices is indoor or outdoor according to moving behaviors of the mobile devices, and arranges the mobile devices that is outdoor in a notification list, and transmits the radio frequency notification to the mobile devices on the notification list.

8. The system of using a base station algorithm to plan an emergent traffic route and inform in advance vehicles to yield right-of-way according to claim 1, wherein the radio frequency notification is transmitted to the mobile devices through cells of the base stations.

9. The system of using a base station algorithm to plan an emergent traffic route and inform in advance vehicles to yield right-of-way according to claim 5, wherein the radio frequency notification is transmitted to the mobile devices through cells of the base stations.

10. The system of using a base station algorithm to plan an emergent traffic route and inform in advance vehicles to yield right-of-way according to claim 7, wherein the radio frequency notification is transmitted to the mobile devices through cells of the base stations.

11. The system of using a base station algorithm to plan an emergent traffic route and inform in advance vehicles to yield right-of-way according to claim 8, wherein a frequency of transmitting the radio frequency notification is dependent on a moving speed of each of the mobile devices, a moving speed of the rescue vehicle, and a relative distance between the mobile device and the rescue vehicle.

12. The system of using a base station algorithm to plan an emergent traffic route and inform in advance vehicles to yield right-of-way according to claim 9, wherein a frequency of transmitting the radio frequency notification is dependent on a moving speed of each of the mobile devices, a moving speed of the rescue vehicle, and a relative distance between the mobile device and the rescue vehicle.

13. The system of using a base station algorithm to plan an emergent traffic route and inform in advance vehicles to yield right-of-way according to claim 12, wherein a frequency of transmitting the radio frequency notification is dependent on a moving speed of each of the mobile devices, a moving speed of the rescue vehicle, and a relative distance between the mobile device and the rescue vehicle.

14. A method of using a base station algorithm to plan an emergent traffic route and inform in advance vehicles to yield right-of-way, comprising steps:
a plurality of base stations persistently receiving a plurality of mobile network signals of a plurality of mobile devices within effective ranges thereof and generating a plurality of pieces of measurement information according to the mobile network signals, wherein the mobile devices is respectively connected with a plurality of vehicles;
after receiving a current position of a rescue vehicle and a destination position of a rescue vehicle, a cloud server receiving and analyzing the pieces of measurement information of the base stations between the current position and the destination position to determine the positioned locations of the mobile devices;
the cloud server planning a fastest route for the rescue vehicle to reach the destination position fastest according to compare the positioned locations with a map; and
the cloud server sending out at least one radio frequency notification through the base stations to the mobile devices, which is on the fastest route, to remind the mobile devices to yield right-of-way.

15. The method of using a base station algorithm to plan an emergent traffic route and inform in advance vehicles to yield right-of-way according to claim 14, wherein the vehicles includes a plurality of autonomous vehicles and a plurality of traditional vehicles; each of the autonomous vehicles includes a control unit and one of the mobile devices; after at least one of the autonomous vehicles receives the radio frequency notification, the control unit controls the autonomous vehicle which received the radio frequency notification to yield right-of-way.

16. The method of using a base station algorithm to plan an emergent traffic route and inform in advance vehicles to yield right-of-way according to claim 14, wherein the measurement information includes at least one of Reference Symbol Received Power (RSRP), Reference Signal Receiving Quality (RSRQ), Signal to Interference plus Noise Ratio (SINR), Channel Quality Indicator (CQI), Angle of Arrival (AoA), Timing Advance (TA), and Round-Trip Time (RTT) of the mobile devices; and Cell-ID, locations, neighborhood lists of base stations, and Channel Status Information (CSI) of the base stations.

17. The method of using a base station algorithm to plan an emergent traffic route and inform in advance vehicles to yield right-of-way according to claim 14, wherein the cloud server plans the fastest route according to lengths of a plurality of routes, quantities of the mobile devices on the routes, moving directions of the mobile devices on the routes, and moving speeds of the mobile devices on the routes; the cloud server lists the mobile devices that is on the fastest route.

18. The method of using a base station algorithm to plan an emergent traffic route and inform in advance vehicles to yield right-of-way according to claim 14, wherein before using the pieces of measurement information of the base stations to calculate the fastest route, the cloud server lists the base stations between the current position of the rescue vehicle and the destination position of the rescue vehicle and analyzes the pieces of measurement information of the base stations.

19. The method of using a base station algorithm to plan an emergent traffic route and inform in advance vehicles to yield right-of-way according to claim 14, wherein the step: “the cloud server sending out the radio frequency notification through the base stations to the mobile devices, which is on the fastest route” includes steps: the cloud server finding out the mobile devices moving on the fastest route currently; determining whether each of the mobile devices is indoor or outdoor according to moving behaviors of the mobile devices, and arranging the mobile devices that is outdoor in a notification list; and transmitting the radio frequency notification to the mobile devices on the notification list.

20. The method of using a base station algorithm to plan an emergent traffic route and inform in advance vehicles to yield right-of-way according to claim 14, wherein the radio frequency notification is transmitted to the mobile devices through cells of the base stations.

21. The method of using a base station algorithm to plan an emergent traffic route and inform in advance vehicles to yield right-of-way according to claim 17, wherein the radio frequency notification is transmitted to the mobile devices through cells of the base stations.

22. The method of using a base station algorithm to plan an emergent traffic route and inform in advance vehicles to yield right-of-way according to claim 19, wherein the radio frequency notification is transmitted to the mobile devices through cells of the base stations.

23. The method of using a base station algorithm to plan an emergent traffic route and inform in advance vehicles to yield right-of-way according to claim 20, wherein a frequency of transmitting the radio frequency notification is adjusted according to a moving speed of each of the mobile devices, a moving speed of the rescue vehicle, a relative distance between the mobile device and the rescue vehicle.

24. The method of using a base station algorithm to plan an emergent traffic route and inform in advance vehicles to yield right-of-way according to claim 21, wherein a frequency of transmitting the radio frequency notification is adjusted according to a moving speed of each of the mobile devices, a moving speed of the rescue vehicle, a relative distance between the mobile device and the rescue vehicle.

25. The method of using a base station algorithm to plan an emergent traffic route and inform in advance vehicles to yield right-of-way according to claim 22, wherein a frequency of transmitting the radio frequency notification is adjusted according to a moving speed of each of the mobile devices, a moving speed of the rescue vehicle, a relative distance between the mobile device and the rescue vehicle.

26. The method of using a base station algorithm to plan an emergent traffic route and inform in advance vehicles to yield right-of-way according to claim 14, wherein based on the mobile network signals and the pieces of measurement information between the current position and the destination position, the cloud server repeatedly analyzes the mobile network signals and the pieces of measurement information of the base stations and performs positioning of the mobile devices to determine the mobile devices entering the fastest route and the mobile devices leaving the fastest route.
